(19) United States
(12) Patent Application Publication
(10) Pub. No.: US 2009/0119961 A1
(43) Pub. Date: May 14, 2009

(54) COMPACT YARD SIGN PACKAGE REINFORCED BY FOLDED BAIL

(76) Inventor: Jeffrey W. Harms, Lawrence, KS (US)

Correspondence Address: POLSINELLI SHUGHART PC, 700 West 47th Street, Suite 1000, KANSAS CITY, MO, 64112, US

(21) Appl. No.: 11/937,892

(22) Filed: Nov. 9, 2007

(51) Int. Cl. G09F 7/18; G09F 7/00

(52) U.S. Cl. 40/607.05; 40/610; 40/606.01

(57) ABSTRACT

A compact yard sign package reinforced by a folded bail includes a sign member formed by a rectangular sheet folded at a fold line to form a sign member including pair of sign panels, side edge regions of the sign panels being joined to form a bail receiving pocket between the sign panels. A hand bendable wire bail is formed by a straight bridge section with legs extending from ends of the bridge at right angles. Outer sections of the legs are bent at right angles to inner sections of the legs to form a folded bail. The folded bail is positioned in the pocket of the sign member to reinforce the sign member during shipping. An end use removes the bail from the pocket and straightens the legs out prior to inserting ends of the legs into the ground to set up the sign assembly.

### BACKGROUND OF THE INVENTION

The present invention relates to temporary yard signs and, more particularly, to a compact yard sign package reinforced by a U-shaped support bail with legs folded and positioned within the sign panels.

Temporary yard or lawn signs are useful for a wide variety of purposes, such as for political campaigning, indicating availability of property for sale or rent or open houses, announcements of yard or garage sales, giving directions to various events or places, and the like. In the past, temporary signs were often formed of a single panel displaying information on only one side and attached to a sign support, such as a long wooden stake, by staples, nails, or similar fasteners. More recently, two sided signs have been devised which are formed by two sheets stapled together or by a single folded-over sheet with the edges joined, as by staples or tape, or sealed by a hot melt adhesive or other adhesive, creating an inverted pocket to receive a sign support, such as a wire bail. The legs are inserted into the ground to set up the sign at its place of use. Other known sign arrangements include metal or plastic sign frames with insertable sign elements.

When a relatively large number of sign assemblies are sent to a single customer, such as a political campaign office, the sign components can be packaged for shipping in a fairly convenient manner by stacking the signs, bundling the bails, and placing the signs and bails in a carton or on a pallet. The signs and bails may also be simply wrapped with a packaging paper or a film. Often, sign manufacturers, either spontaneously or on request, send a sample sign kit to a prospective sign buyer, such as a worker at a political campaign office. For a prospective sale, it is desirable that the sign components arrive at the customers location in an undamaged condition. Typically, such a sample sign kit 200 (FIG. 3) would be shipped in a large flat carton 202, as by a package delivery service or the like. The carton 202 needs to be large enough to accommodate the U-shaped bail 204, with the sign member itself positioned between the legs of the bail. The bail may be secured to a panel 206 of the carton as by the use of tape, with the sign member protected by an envelope 208 taped or otherwise adhered to the panel 206. Often, the carton 202 weighs as much as or more than the actual sign kit 200 and is typically larger than the sign kit. Since postage or shipping charges are often based on a combination of weight of the carton with contents and total dimensions (length plus width plus depth) of the carton, the cost of mailing or shipping a single sign kit can be relatively expensive.

What is needed is a economical and convenient way to ship a single yard sign kit, or a small number of sign kits, which adequately protects the sign components during shipping.

### SUMMARY OF THE INVENTION

The present invention provides embodiments of a compact sign package in which portions of legs of a U-shaped wire bail are folded into overlapping, or near overlapping, relation and the bail, thus folded, is positioned between panels of a double paneled sign member. In this manner, the bail reinforces the sign panels and reduces damage thereto during shipping. The recipient of the sign package can separate the bail from the folded sign card, fold the leg portions out straight, and insert a top section of the bail between the panels for display of the sign.

The sign member can be formed by a single unfolded sheet, a single folded sheet, or a pair of separate sheets. The sheets may be left blank or imprinted on one or both sides, as desired by the recipient. In one embodiment of the compact sign package, a sign member or card is formed by a sheet of sign stock which is preprinted with a desired message, graphics, and/or an image. The sheet is folded in half at a fold line to form the sign panels, with ends of the panels opposite the fold line aligned. Side edges of the panels are aligned and joined, as by an adhesive. If the sign stock is of a variety which is coated and impregnated with a suitable polymer, the side edges may be joined by ultrasonic heating of side edge regions to fuse the coating on inside surfaces of the sign panels, as detailed in U.S. Pat. No. 7,101,450 which is incorporated herein by reference. Joining of the side edges of the sign panels forms a bail receiving pocket within the sign member which is sized to receive an upper end of a rectangular, U-shaped wire bail to form a sign assembly. The fold line of the sign member, side edges, and end edges of the sign panels, form a sign perimeter of the sign member.

The bail or wicket includes a straight upper bridge with a pair of elongated legs extending from ends thereof at approximately right angles. In a folded condition of the compact sign package, outer or lower sections of the legs are folded inward into mutual overlapping relation at approximately right angles to inner or upper sections of the legs. In the folded condition, the bail is sized to fit at least mostly within the pocket of the sign member. Preferably, the folded bail is sized to fit entirely within the perimeter of the sign member and, ideally, entirely within the pocket. The bail is formed of a hand bendable material, such as a steel wire, and the radius of the bends of the leg sections is selected to facilitate bending the outer leg sections by hand into approximate alignment with their respective inner leg sections, that is, in approximate parallel relation of the outer legs. The outer leg sections are usually bent to the unfolded condition by a recipient of the sign package, prior to inserting ends of the bail legs into the ground to set up the sign assembly.

The bail in the folded condition is preferably positioned within the pocket of the sign member with the overlapping outer leg sections adjacent the fold line and with the bridge near the end edges of the sign panels. Orientation of the folded bail in this manner prevents ends of the bail from protruding out of the sign member and possible sharp edges of the ends causing injury or damage. In contrast, when the legs are unfolded and the bail is inserted into the sign member to set up the sign assembly, the bridge of the bail is positioned near the fold line of the sign member. To reduce damage to the sign package during shipping, the sign package may be placed in an outer envelope, which may be a paper envelope or an envelope formed of a heat shrink material. The outer envelope also provides a surface to receive shipping labels and the like, including postage if the sign package is mailed. The presence of the folded bail within the sign package reinforces the sign package to thereby further limit damage to the sign member during shipping, as by resisting bending of the sign package. Positioning the bail within the pocket also preserves the appearance of the sign imprint by preventing the bail wire, and especially ends of the bail, from contact with the printed outer surfaces of the sign member. It is also possible to assemble the sign package of the present invention with the bail within the envelope, but not positioned in the pocket. This situation might occur if the sign member is a single unfolded sheet or if the sign member is formed by a pair of unjoined sheets. To better avoid possible damage to the sign imprint by the bail, the bail may be separated from the sign member by a sheet of paper, plastic film, or the like.

The manufacturers of yard and lawn signs periodically hold trade shows to make their products and services known to prospective buyers and to solicit orders for their wares. Manufacturers representatives and marketing personnel often pass out literature and brochures which describe their products and services and may include price lists, turn-around times for orders, and the like. Additionally, the representatives often pass out sample signs to show the configurations and quality of their work. The compact sign package of the present invention are particularly well adapted for passing out as sign samples, since a complete sign kit including a sign member and a usable bail in a folded condition can be provided in a compact package which is convenient for a buyer to carry around the trade show. The bail receiving pocket of the sign member, in an inverted orientation, may also function as a carrier for literature and brochures handed out at the show. An embodiment of the compact sign package is further modified to enhance the convenience of such a sample sign. The modified sign package includes a sign member formed by a folded sheet with side edges joined. Near the end edges of the sign member, aligned hand hold regions of the sign panels are partially punched through the panels and can be cooperatively folded underneath the bridge of the folded bail within the pocket to provide a convenient grip for the sign.

Although the sign assembly of the present invention is usually assembled using the folded wire bail, some locales require that temporary signs be supported by wooden stakes. Also, some sign customers prefer the use of such stakes. An embodiment of the compact sign package is modified for use either with a wire bail, sent as part of the package, or a wooden stake, usually supplied by the recipient. A sign member is formed by a sheet folded at a fold line to form sign panels. Edges of the sign panels may be joined to form a bail receiving pocket. A stake receiving opening is formed near the fold line, such as a linear slit or an arcuate cutout. To set such a sign assembly up, a flat stake is extended through the pocket and through the opening a short distance to clear an end surface of the stake. The sign member can be secured to the stake by one or more staples extending through one or both sign panels and into the stake. The sign assembly can be set up in a desired location by hammering the stake into the ground, with the top end surface of the stake exposed through the opening for striking. Alternatively, the sign member can be stapled or otherwise attached to the stake prior to hammering the sign assembly into the ground. While the side edges of the sign panels are usually joined, it is also preferred by some sign buyers that the sign member be provided with the edges not joined. In such a case, the end user can join any desired portion of the sign panels, as by staples, tape, or the like. The sign package with the stake opening is provided with a bail in the folded condition to give the user the option of using the bail or a stake to support the sign member. The bail in the sign package also reinforces the sign package to reduce the likelihood of damage to the sign member during shipping.

Objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of an embodiment of a compact yard sign package reinforced by a folded bail according to the present invention with portions broken away to show internal detail.

FIG. 2 is an enlarged cross sectional taken on line 2-2 of FIG. 1 and illustrates details of the sign package with an outer envelope removed.

FIG. 3 is a perspective view at a reduced scale showing a conventional package for a single sign member and support bail.

FIG. 4 is an enlarged side elevational view of a sign support bail according to the present invention shown in a folded condition, with a perimeter of the sign member shown in phantom lines.

FIG. 5 is a perspective view illustrating bending of a leg of the folded sign support bail to an unfolded condition.

FIG. 6 is a perspective view of an alternative embodiment of a compact sign package according to the present invention including partially punched regions forming a hand hold for convenient carrying of the sign package.

FIG. 7 is a perspective view of an embodiment of the compact sign package with legs of the sign support bail bent to an unfolded condition, with ends of the legs inserted into the ground.

FIG. 8 is a fragmentary perspective view of an alternative embodiment of a compact sign package formed using a flexible sign member material.

FIG. 9 is a perspective view of an alternative embodiment of the sign support package including an opening at a fold line of the sign member to allow a sign support stake to pass therethrough.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

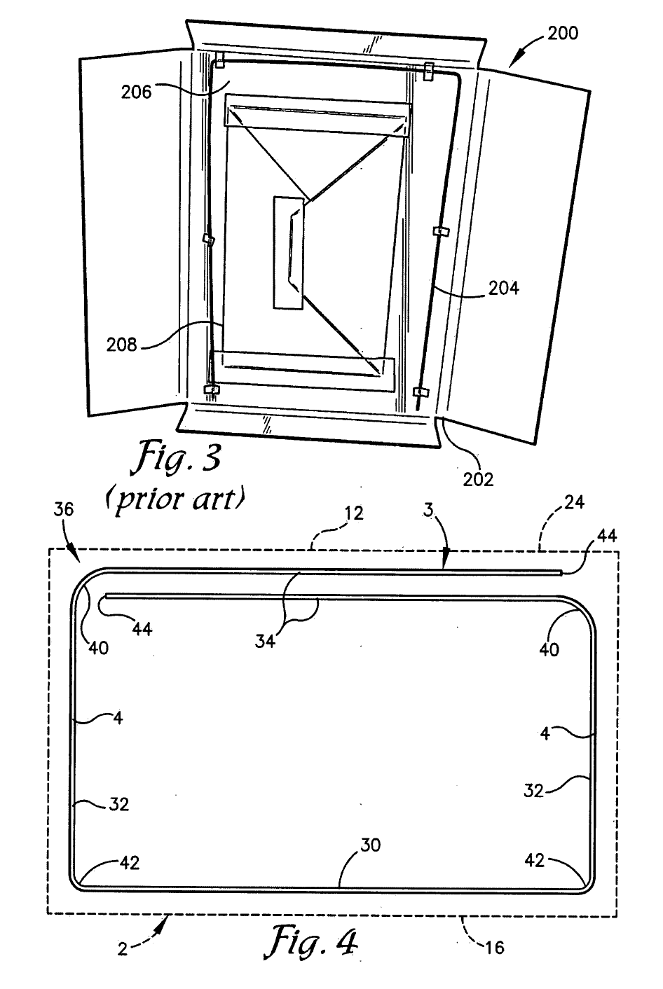

Referring to the drawing in more detail, the reference numeral 1 generally designates an embodiment of a compact sign package reinforced by a folded bail according to the present invention. The sign package 1 generally includes a sign member 2 and a sign support bail 3. Within the sign package 1, portions of legs 4 of the bail 3 are folded to reduce the size of the bail and the resulting package when combined with the sign member 2. In general, the sign package 1 is greatly reduced in size and weight compared to the conventional type of sign package 200 shown in FIG. 3, resulting in greater economy in shipping the sign package 1.

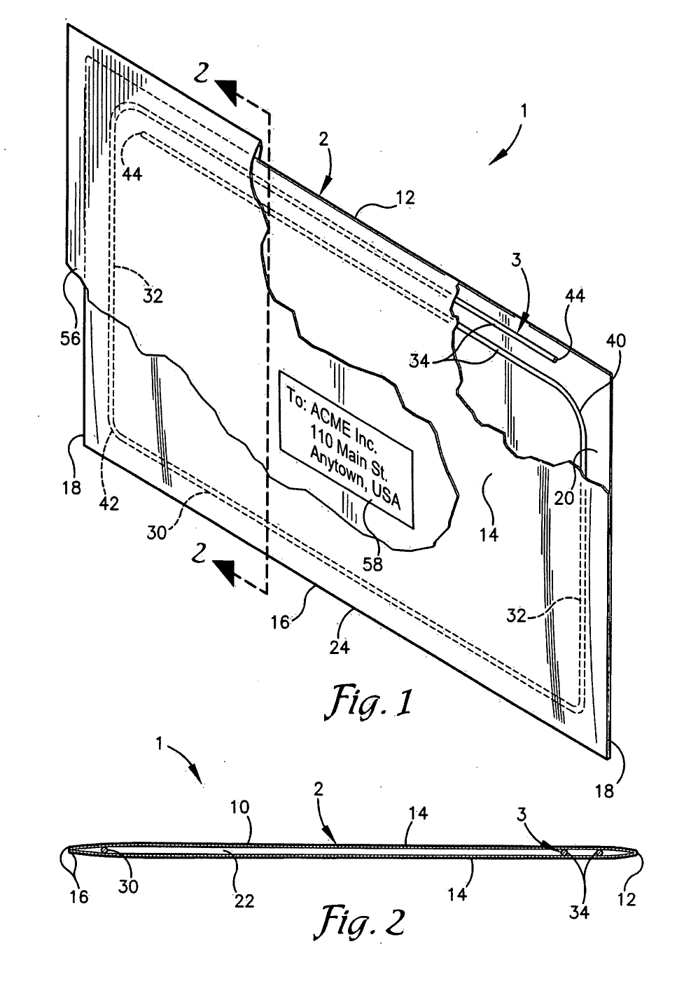

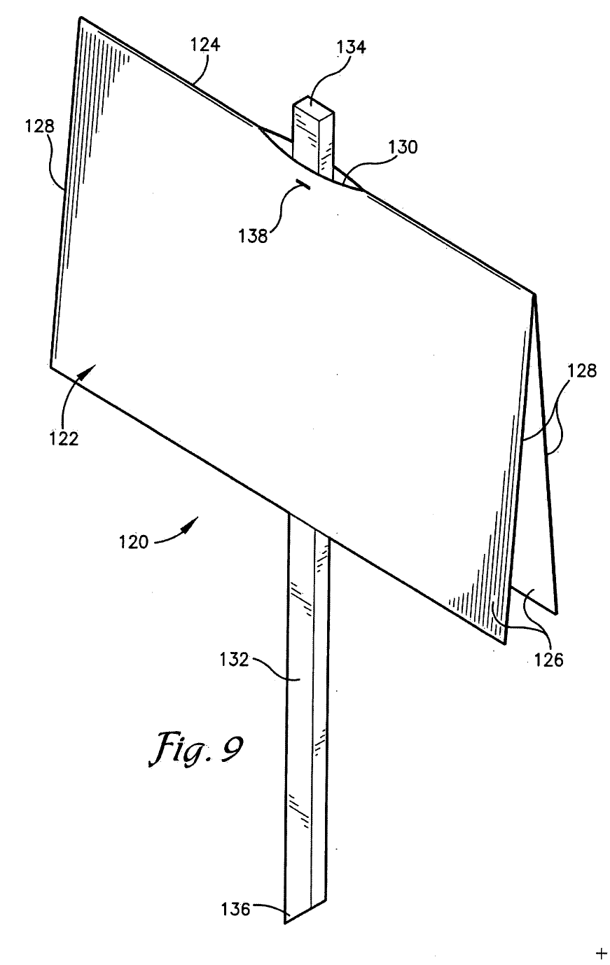

Referring to FIGS. 1 and 2, the illustrated sign member 2 is formed of a rectangular sheet 10 of card stock which is folded at a fold line 12 to form a pair of sign panels 14. The sign panels 14 are preprinted with an image and/or a written message, such as for a political campaign, a real estate availability, a yard/garage sale, or the like. In the illustrated sign member 2, end edges 16 of the sheet 10, opposite the fold line 12, are mutually aligned, as are side edges 18. In the illustrated embodiment of the sign package 1, side edge regions 20 of the sign panels 14 are joined to form a pocket 22 (FIG. 2) within the sign member 2 between the sign panels 14. The fold line 12, end edges 16, and opposite side edges 18 form a rectangular perimeter 24 of the sign member 2. The side edge regions 20 can be joined by an adhesive, such as a hot melt adhesive, by stapling, by riveting or the like. It is also foreseen that the sign member 2 can be provided with the edge regions 20 unjoined, as shown if FIG. 9. The edge regions 20 can then be joined, if desired, by the end user of the sign package 1.

A particularly suitable sign stock for the sheet 10 is so-called milk carton stock which is usually coated on both sides with a fusible resin or polymer such as polyethylene. The polymer also impregnates the paper-like base stock. Sign stock suitable for the yard signs may have a thickness ranging from about 0.015 to 0.025 inch (0.38 to 0.64 mm). Side edge regions 20 of the sign panels 14 formed of the polymer coated stock can be joined by fusing the coating along the side edge regions 20 on inside surfaces of the sign panels 14, as by ultrasonic or other types of heating. The polymer coating may be about 0.5 mil (0.0127 mm) on outer surfaces of the panels 14, for adequate weathering characteristics, and about 0.875 mil (0.0222 mm) on the inner surfaces to facilitate fusing to join the side edge regions 20. Further details forming signs in this manner can be found in the previously referenced U.S. Pat. No. 7,101,450.

While the sign package 1 is described in connection with a sign member 2 formed of a folded sheet 10 of polymer coated and impregnated card stock, it is also foreseen that the sign member 2 could alternatively be formed of a single unfolded sheet of a coated or uncoated paper material, a pair of such sheets, one or two sheets of a stiff polymer material, various kinds of laminates, an extruded corrugated polymer material such as Coroplast (trademark of Coroplast, Inc., www.coroplast.com) or the like, or combinations of such materials. The sign member 2 may also be formed of a flexible polymer film, as described in more detail below.

Referring to FIG. 4, the sign support bail 3 includes a bridge or bridge section 30 with the legs 4 extending therefrom at approximately right angles. Each leg 4 includes an inner or proximal leg section 32 and an outer or distal leg section 34. FIG. 4 illustrates the bail in a folded condition or configuration 36 in which the outer leg sections 34 are bent at approximately right angles to the inner leg sections 32. In contrast, FIG. 7 shows the bail 3 in an unfolded condition 38 in which the outer leg sections 34 are bent into approximate alignment with the inner leg sections 32 and in which the lower leg sections 34 are approximately parallel. As shown in FIGS. 1 and 4, when the bail 3 is in the folded condition 36, all portions of the bail 3 fit within the perimeter 24 of the sign member 2 to thereby form the compact sign package 1. The present invention is also intended to encompass configurations in which the bail 3 in the folded condition 36 is reduced in area so that the bail 3 fits mostly within the perimeter 24 of the sign member 2. As a practical matter, for the bail 3 to cooperate with the sign member 2 to support it, the bridge 30 should be shorter in length than the length of the end edges 16 or the fold line 12. The size of the sign package 1 is beneficially reduced if at least most of the bail 3, in the folded condition 36, fits within the perimeter 24 of the sign member 2.

It should be noted in FIG. 4 that leg bends 40 between the inner and outer leg sections 32 and 34 have a larger radius than bridge bends 42 between the bridge 30 and the inner leg sections 32. The larger radius of the leg bends 40 facilitates bending the outer leg sections 34 into the unfolded condition by hand. The leg bends 40 may have a radius of about 1.5 to 4 inches (3.81 to 10.16 cm). In contrast, the bridge bends 42 may have a radius of about 0.25 to 0.375 inch (6.35 to 9.53 mm). The bail 3 is preferably formed from a hand bendable wire which also has the required strength and other characteristics to support the sign member 2. A suitable type of metal for the wire forming the bail 3 is one of a family of carbon steels which are referred to as “1018” steels. The wire may have a diameter ranging from about 0.162 to 0.187 inch (4.11 to 4.75 mm). The larger diameter is for use with “jumbo” yard signs which are about 20% larger than standard sized sign members 2, measuring about 16 by 26 inches (40.64 to 66.04 cm). The larger sign members require a sturdier bail for adequate support to avoid vulnerability to bending from wind loads on the larger sign members.

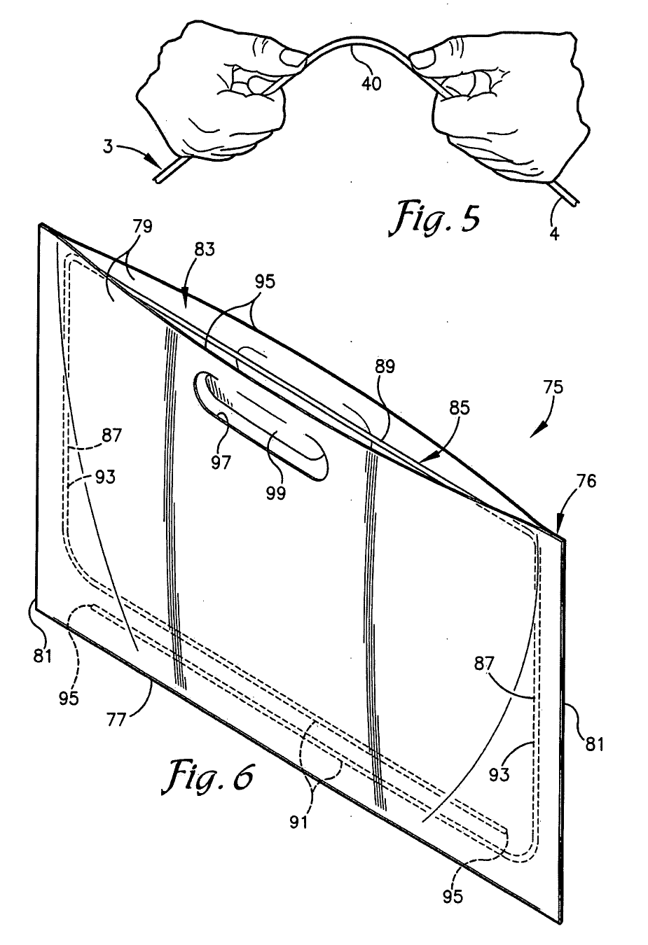

As shown in FIGS. 1, 2, and 4, when the sign package 1 is assembled for shipping, the bail 3, in the folded condition 36, is positioned within the pocket 22 formed by the sign panels 14 of the sign member 2. It is preferred that the bail 3 is oriented so that the folded outer legs 34 are positioned next to the fold line 12 with the bridge 30 positioned near the end edges 16. The reason for this orientation is that ends 44 of the outer leg sections 34 can have sharp edges which can cause injury or damage if they protrude from the sign package 1 through the opening of the pocket 22 at the end edges 16. When the sign assembly 48 (FIG. 7) is to be set up, the folded bail 3 is removed from the pocket 22 of the sign member 2, the legs 4 are straightened (FIG. 5) by bending the outer leg sections 34 into approximate alignment with the inner leg sections 32. A portion of the bail 3 is then inserted back into the pocket 22 until the bridge 30 engages the folded sign sheet 10 at the fold line 12. Finally, the sign assembly 48, including the sign member 2 positioned on the bail 3 in its unfolded condition 38 is set up by inserting ends 44 of the legs 4 into the ground 50.

The sign package 1 may include an outer envelope 56 to protect the sign package during shipping. The envelope 56 may be a plastic film, as illustrated in FIG. 1, a paper envelope, or the like. The film may, for example, be a heat shrink wrap. The envelope 56 provides a surface to receive shipping labels, such as the illustrated address label 58, postage, a return address label, or the like. The envelope 56 protects the surfaces of the sign panels 14 from scratches, scuffs, and similar damage to the surface of the sign member 2 while the presence of the bail 3 in the folded condition 36 resists bending and folding of the sign member 2. While the sign package 1 is described in terms of a folded sign member 2 with a folded bail 3 positioned between the sign panels 14, it is foreseen that the sign member 2 could be a single, unfolded sheet or card. Such a simplified sign member 2 could be reinforced by a bail 3 in the folded condition 36 in which the single layer sign member 2 and folded bail 3 are packaged within an outer envelope 56.

Referring to FIG. 6, samples of yard signs are sometimes given out or sold at various kinds of trade shows, including trade shows for the temporary sign industry. In addition to sample signs, exhibiters often pass out literature to attendees describing their products, services, price lists, and the like. A trade show embodiment 75 of the compact sign package of the present invention provides a convenient sample sign for such a trade show. The sign package 75 includes a sign member 76 sheet of folded sign stock folded at a fold line 77 to form a pair of sign panels 79, which may be preprinted with a desired message or image. Regions of the sign panels 79 near side edges 81 thereof are joined, as described above, to form a pocket 83 between the sign panels 79. A bail 85 with legs 87 extending from a bridge 89 has outer leg sections 91 folded at approximately right angles to inner leg sections 93. The folded bail 85 is positioned within the pocket 83 of the sign member 76 with the outer leg sections 91 adjacent the fold line 77 and with the bridge 89 near end edges 95 of the sign panels 79. The sign package 75 can be carried in an inverted orientation, as illustrated in FIG. 6 to form a carrier for trade show literature or other flat articles. In order to facilitate carrying the sign package 75, the sign panels 79 are partially punched near the end edges 95 to form hand hold openings 97. Hand hold tabs or punch-out tabs 99 formed by the punched openings 97 can be folded underneath the bridge 89 of the folded bail 85 to provide a secure hold on the sign package 75 for carrying the sample sign about the trade show and placing trade show literature in the pocket 83 of the sign package 75.

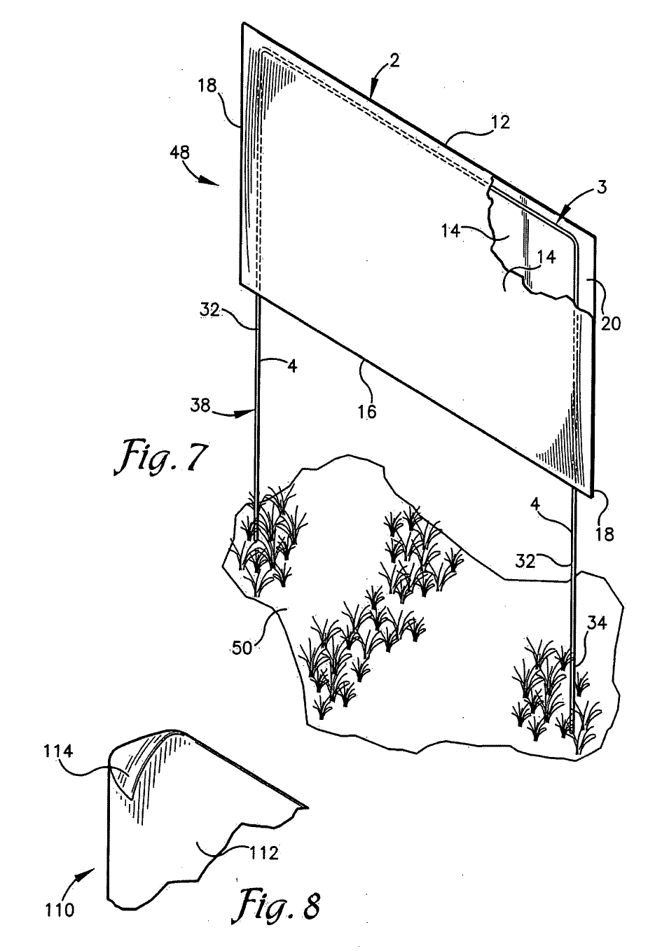

While some embodiments of the sign member 2 are formed of various kinds of relatively stiff card stock, it is also foreseen that the sign member 2 could be formed of one of various kinds of flexible plastic films, such as polyethylene, polypropylene, polyvinyl chloride (PVC), polyolefin, cellophane, acetate, nylon, or a spunbonded olefin such as Tyvek (DuPont brand) or composites including such films. Such films can be preprinted with images and/or lettered messages for various purposes. FIG. 8 illustrates a sign package 110 including a sign member 112 formed of a flexible plastic film. As illustrated, corners 114 of the sign member 112 are flexible and can be bent during handling and shipping. The types of plastics used for such films are generally fairly rugged so that flexing or bending of the corners 114 does not damage the sign member 112 appreciably. Additional shipping protection for a sign package 110 with a sign member 112 formed of a flexible film can be provided by an outer envelope formed of paper or the like.

In some areas, it is preferred to support temporary signs using wooden stakes. For such usage, the present invention provides a sign package 120 suitable for use with such a stake. The sign package 120 includes a sign member 122 formed by a rectangular sheet folded at a fold line 124 to form a pair of sign panels 126. The illustrated sign member 122 does not have side edge regions near side edges 128 joined, although it is foreseen that the side edge regions could be joined in a manner as described above. The sign member 122 is provided with an opening 130 near the fold line 124. The opening 130 may simply be a slit that is cut when the fold line 124 is scored into the sheet forming the sign member 122 or may be a cutout, such as an arcuate cutout. When the sign package 120 is assembled, a stake 132 is extended between the sign panels 126 and through the opening 130 to expose a top end surface 134 of the stake. A typical stake 132 has a 0.625 by 1.5 inch cross section (1.59 by 3.81 cm) and approximately 4 feet long (1.22 m) and has an angled or otherwise sharpened lower end 136 to facilitate hammering the stake into the ground.

The sign member 122 can be secured to the stake 132, as by one or more staples 136 extending through the sign panels 126 and into the stake 132. Alternatively, the sign member 122 can be secured to the stake 132 by tape or the like. Exposure of the end surface 134 of the stake 132 allows the stake to be hammered into the ground without marring the sign member 122. Alternatively, the stake 132 can be hammered into the ground and the sign member 122 secured to the erected stake. When a stake 132 is intended to be used to support the sign member 122, the stake is typically supplied by the end user of the sign package 120. The sign package 120 may be provided with a folded bail (not shown) similar to the bail 3 to reinforce the package during shipping. The end user then has the option of using the bail or a stake 132 to support the sign member 122.

It is to be understood that while certain forms of the present invention have been illustrated and described herein, it is not to be limited to the specific forms or arrangement of parts described and shown.

What is claimed and desired to be secured by Letters Patent is:

1. A compact sign and support bail package comprising:
(a) a sheet of sign material having outer edges forming an outer sign perimeter;
(b) a hand bendable wire support bail having a bridge and a pair of legs extending from said bridge, said sheet being selectively joined to said bail to support said sheet;
(c) said bail having a folded condition in which each of said legs has a distal portion directed generally at right angles toward the other leg; and
(d) said bail having an unfolded condition in which said distal portions are bent to project in generally parallel relation.

2. A package as set forth in claim 1 wherein:
(a) said sheet and said bail are of such relative sizes that at least a substantial portion of said bail lies within said sign perimeter when overlaid on said sheet.

3. A package as set forth in claim 1 wherein:
(a) said bail in said folded condition is receivable entirely within said perimeter.

4. A package as set forth in claim 1 wherein:
(a) said sign sheet has opposite end edges and opposite side edges;
(b) said sheet is folded about a fold line to form a pair of sign panels, said fold line forming one of said outer edges, said side edges forming additional ones of said outer edges, and at least one of said end edges forming one of said outer edges; and
(c) adjacent side edges of the folded sheet are joined to form a pocket to receive said bail in said folded condition and a portion of said bail in said unfolded condition.

5. A package as set forth in claim 1 wherein said sign card includes:
(a) a rectangular sheet of sign material having opposite end edges and opposite side edges;
(b) said sheet being folded about a fold line to form a pair of sign panels, said fold line forming one of said outer edges, said side edges forming additional ones of said outer edges, and at least one of said end edges forming one of said outer edges; and
(c) said sheet including an opening along said fold line to enable partial separation of portions of said sign panels allowing a sign support stake to pass therethrough.

6. A package as set forth in claim 1 wherein said sign card includes:
(a) a rectangular sheet of sign material having opposite end edges and opposite side edges;
(b) said sheet being folded about a fold line to form a pair of sign panels, said fold line forming one of said outer edges, said side edges forming additional ones of said outer edges, and at least one of said end edges forming one of said outer edges;
(c) adjacent side edges of the folded sheet being joined to form a pocket sized to receive said bail in said folded condition and a portion of said bail in said unfolded condition; and
(d) an outer envelope having said folded sheet positioned therein, said folded sheet having said bail in said folded condition positioned therein.

7. A package as set forth in claim 6 wherein:
(a) said envelope is formed of a heat shrink material.

8. A package as set forth in claim 1 wherein said sign card includes:
(a) a rectangular sheet of sign material having opposite end edges and opposite side edges;
(b) said sheet being folded about a fold line to form a pair of sign panels, said fold line forming one of said outer edges, said side edges forming additional ones of said outer edges, and at least one of said end edges forming one of said outer edges;
(c) adjacent side edges of the folded sheet being joined to form a pocket sized to receive said bail in said folded condition and a portion of said bail in said unfolded condition; and
(d) a pair of aligned hand hold regions partially punched through said sign panels adjacent said outer edges and cooperatively foldable to form a handle about a portion of said bail positioned within said pocket to facilitate carrying said package in an inverted orientation and to enable placement and retention of an article within said pocket.

9. A sign and support bail package comprising:
(a) sign stock folded along a fold line and forming opposed sign panels with respective, oppositely positioned side edges and respective upper and lower end edges; and
(b) a hand bendable wire bail adapted to support said sign stock and having a bridge wire and a pair of leg wires extending therefrom, said leg wires each having a distal portion directed toward the other leg wire.

10. The sign and support bail package as set forth in claim 9 wherein:
(a) said wire bail is removably positioned at least in part between said opposed sign panels.

11. The sign and support bail package as set forth in claim 9 wherein:
(a) said upper and lower edges and said side edges form a perimeter; and
(b) said wire bail is substantially contained within said perimeter.

12. The sign and support bail package as set forth in claim 9 wherein:
(a) said side edges of said sign panels are joined together whereby a pocket is formed by said sign panels; and
(b) said wire bail is substantially contained within said pocket.

13. The sign and support bail package as set forth in claim 9 wherein:
(a) said leg wires extend from said bridge wire at approximately a right angle.

14. The sign and support bail package as set forth in claim 9 wherein:
(a) said leg wire distal portions extend from its leg portion at approximately a right angle.

15. The sign and support bail package as set forth in claim 9 wherein:
(a) said sign stock is cardboard between 0.015 and 0.025 inch (0.38 and 0.64 mm) in thickness.

16. The sign and support bail package as set forth in claim 9 wherein:
(a) said sign stock is flexible plastic sheet material.

17. A compact sign package comprising:
(a) a sign member formed of a sheet of sign stock folded at a fold line to form a pair of sign panels having opposite side edges and having end edges spaced from said fold line; said fold line, said side edges and said end edges forming a sign perimeter;
(b) a sign support bail formed of hand bendable wire and having a bridge section with a pair of legs extending therefrom, said legs having inner sections adjacent said bridge section and outer sections extending from said inner sections, said bail having a folded condition in which said outer sections of said legs are bent inwardly into substantially overlapping relation and an unfolded condition in which said outer sections are generally parallel;
(c) said bail being dimensioned to enable removable positioning of said bail in said folded condition between said sign panels with portions of said bail positioned substantially within said sign perimeter to thereby form said compact sign package for shipping; and
(d) said bail in said unfolded condition having said bridge and portions of said inner sections of said legs positioned within said sign member to support said sign member.

18. A package as set forth in claim 17 wherein:
(a) adjacent side edges of said sign panels are joined to form a pocket to receive said bail in said folded condition and a portion of said bail in said unfolded condition.

19. A package as set forth in claim 17 wherein:
(a) adjacent side edges of said sign panels are joined to form a pocket to receive said bail in said folded condition and a portion of said bail in said unfolded condition; and
(b) said bail in said folded condition is positioned within said pocket with said distal portions of said legs adjacent said fold line and said bridge adjacent said end edges of said sign member.

20. A package as set forth in claim 17 wherein:
(a) said sign member includes a slit formed at said fold line to enable partial separation of portions of said sign panels at said fold line to enable a sign support stake to pass therethrough.

21. A package as set forth in claim 17 and including:
(a) an outer envelope having said sign member positioned therein, said sign member having said bail in said folded condition positioned therein.

22. A package as set forth in claim 17 wherein:
(a) adjacent side edges of said sign panels are joined to form a pocket sized to receive said bail in said folded condition and a portion of said bail in said unfolded condition; and
(b) a pair of aligned hand hold regions are partially punched through said sign panels adjacent said outer edges and cooperatively foldable to form a handle about a portion of said bail positioned within said pocket to facilitate carrying said package in an inverted orientation and enabling placement of an additional flat article within said pocket.
